(19) United States
(12) Patent Application Publication
(10) Pub. No.: US 2006/0099441 A1
(43) Pub. Date: May 11, 2006

(54) Diffusing substrate

(75) Inventors: Laurent Teyssedre, Paris (FR); Thomas Bertin Mourot, Paris (FR); Aurelia Prat, London (FR)

Correspondence Address: OBLON, SPIVAK, MCCLELLAND, MAIER & NEUSTADT, P.C., 1940 DUKE STREET, ALEXANDRIA, VA, 22314, US

(73) Assignee: Saint-Gobain Glass France, Courbevoie (FR)

(21) Appl. No.: 10/527,340

(22) PCT Filed: Sep. 3, 2003
(86) PCT No.: PCT/FR03/02631

§ 371 Date: Sep. 26, 2005

(30) Foreign Application Priority Data
Sep. 11, 2002 (FR) 02/11225

(51) Int. Cl. C25D 11/02; C03C 27/08; C03C 27/02

(52) U.S. Cl. 428/633; 428/627; 428/629; 428/632

(57) ABSTRACT

Diffusing substrate (20) comprising a glass substrate (21) and a diffusing layer (22) deposited on the said glass substrate, characterized in that the glass substrate (21) has a light transmission at least equal to 91% calculated over the 380 to 780 nm wavelength range according to the EN 410 standard.

The present invention relates to a diffusing substrate for making a light source uniform.

The invention will be more particularly described with reference to a diffusing substrate used for making the light emitted by a backlighting system uniform.

A backlighting system, which consists of a light source or backlight, is used, for example, as backlighting source for liquid-crystal screens, also called LCD screens. It turns out that the light thus emitted by the backlighting system is not sufficiently uniform and exhibits overly strong contrasts. Diffusing means associated with the backlighting system are therefore needed to make the light uniform.

Among liquid-crystal screens, a distinction may be made between screens that incorporate a structure called “direct light”, for which the light sources are located inside an enclosure and the diffusing means are placed in front of the light sources, and screens that incorporate a structure called “edge light” for which the light sources are positioned on the side of the enclosure, the light being conveyed to the diffusing means at the front face by a waveguide. The invention relates more particularly to LCD screens with a direct-light structure.

The invention may also be used when it is desired to make the light coming from architectural flat lamps uniform, these lamps being used, for example, on ceilings, floors or walls. They may also be flat lamps for municipal use, such as lamps for advertising panels or else lamps that can constitute shelves or bottoms of display windows.

One satisfactory solution from the uniformity stand-point consists in covering the front face of the backlighting system with a sheet of plastic, such as a polycarbonate or an acrylic polymer bulk-filled with mineral fillers, the sheet having a thickness of 2 mm for example. However, since this material is heat-sensitive, the plastic ages badly and the heat generated generally results in structural deformation of the plastic diffusing means, which is manifested by non-uniformity of the luminance of the projected image on the LCD screen for example.

It may therefore be preferred to use, as diffusing means, a diffusing layer such as that described in French Patent Application published under No. 2 809 496. This diffusing layer composed of agglomerated particles in a binder is deposited on a substrate, for example made of glass.

However, the inventors have shown that the use of such diffusing means causes, at the interfaces with the glass substrate, many reflections of the light generated by the backlighting system. Furthermore, although the backlighting system possesses reflectors for reflecting the light reflected by the glass substrate that could not be transmitted, the light sent back by the reflectors towards the glass substrate is, however, only partly transmitted, a portion being again reflected and sent back once more by the reflectors, and so on. Thus, all the light is not transmitted immediately the backlighting system is operated, but travels forwards and backwards several times before passing through the diffusing substrate, with some losses. The inventors have chosen to call this phenomenon the “recycling” phenomenon.

Having demonstrated this recycling phenomenon, which problem had hitherto never been eliminated, the inventors have established that it is necessary to study the quality of transmission of the light through the diffusing substrate in order to obtain suitable luminance of the illumination emanating from the substrate.

Moreover, the inventors have shown that too thick a glass substrate can generate excessive absorption and consequently can generate insufficient luminance, resulting in a lowering of the luminance of the image on an LCD screen for example.

The object of the invention is therefore to provide a diffusing substrate that includes a glass substrate coated with a diffusing layer and that makes it possible to optimize the luminance of the illumination generated by means of such a substrate.

According to the invention, to optimize the luminance of the illumination generated by means of the diffusing substrate that includes a glass substrate and a diffusing layer deposited on the said glass substrate, the diffusing substrate is characterized in that the glass substrate has a light transmission at least equal to 91%, and preferably at least equal to 91.50%, calculated over the 380 to 780 nm wavelength range according to the EN 410 standard, for a glass having an index of 1.52±0.04.

The inventors have been able to demonstrate that the luminance, which depends on the quality of the light transmission of the substrate, depends on parameters such as the linear absorption coefficient and the thickness of the glass substrate, the linear absorption coefficient being tied to the glass composition of the substrate.

Thus, according to one feature, the glass substrate has a total iron content such that:

$${[ {Fe}_{2} {O}_{3} ]}_{t} \leq \frac{7110}{( 1.52 \times e + 0.015 ) + ( 17.24 \times e + 0.37 ) \times redox}$$

with [Fe₂O₃]ₜ expressed in ppm and corresponding to the total iron in the composition, e being the thickness of the glass in mm and the redox being defined by redox=[FeO]/[Fe₂O₃]ₜ, the redox being between 0 and 0.9.

According to another feature, the iron content must be even further limited if the light transmission is at least equal to 91.50%. This content is then such that:

$${[ {Fe}_{2} {O}_{3} ]}_{t} \leq \frac{2110}{( 1.52 \times e + 0.015 ) + ( 17.24 \times e + 0.37 ) \times redox}$$

with [Fe₂O₃]ₜ expressed in ppm and corresponding to the total iron in the composition, e being the thickness of the glass in mm and the redox being defined by redox=[FeO]/[Fe₂O₃]ₜ, the redox being between 0 and 0.9.

Also, according to a first embodiment, the glass substrate has a minimum light transmission of 91.50% for a thickness e of at most 4.0 mm, with a total iron content of 200 ppm and a redox of less than 0.05.

According to a second embodiment, the glass substrate has a minimum light transmission of 91% for a thickness e of at most 4.0 mm, with a total iron content of 160 ppm and a redox of 0.31. For the same iron content and redox, the thickness e will be at most 1.5 mm in order to ensure the 91.50% minimum light transmission property.

Again, according to a third embodiment, the glass substrate has a minimum light transmission of 91% for a thickness e of at most 1.2 mm, with a total iron content of 800 ppm and a redox of 0.33.

According to yet another embodiment, the glass substrate has a minimum light transmission of 91% for a thickness e of at most 1.2 mm, with a total iron content of 1050 ppm and a redox of 0.23.

According to one feature, the glass composition of the glass substrate of the invention comprises at least the following constituents:

| | % by weight |
|---|---|
| SiO₂ | 65-75 |
| Al₂O₃ | 0-5 |
| CaO | 5-15 |
| MgO | 0-10 |
| Na₂O | 5-20 |
| K₂O | 0-10 |
| BaO | 0-5 |
| ZnO | 0-5 |

According to another feature, the diffusing layer of the substrate of the invention is composed of agglomerated particles in a binder, the said particles having a mean diameter of between 0.3 and 2 microns, the said binder being in a proportion of between 10 and 40% by volume and the particles forming aggregates whose size is between 0.5 and 5 microns. The particles are semi-transparent particles and preferably mineral particles, such as oxides, nitrides and carbides. The particles are preferably chosen from silicon, aluminium, zirconium, titanium and cerium oxides, or a mixture of at least two of these oxides. For further details, reference may be made to the published application FR 2 809 496.

Finally according to the invention, this diffusing substrate will in particular be used in a backlighting system that can be provided in an LCD screen or in a flat lamp.

Other advantages and features of the invention will become apparent in the rest of the description in conjunction with the appended drawings in which:

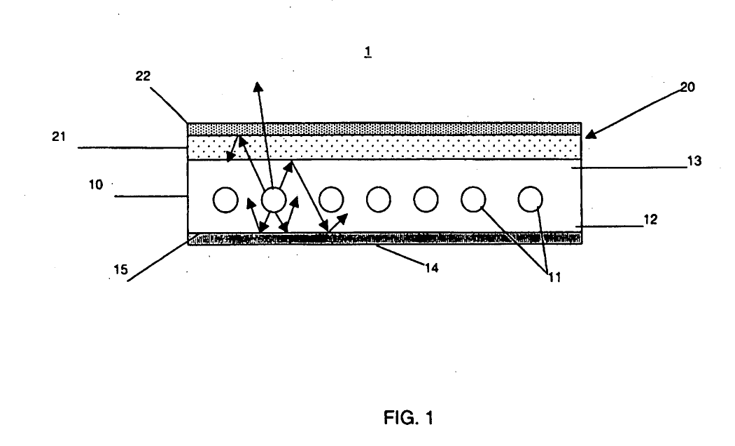

FIG. 1 illustrates a backlighting system;

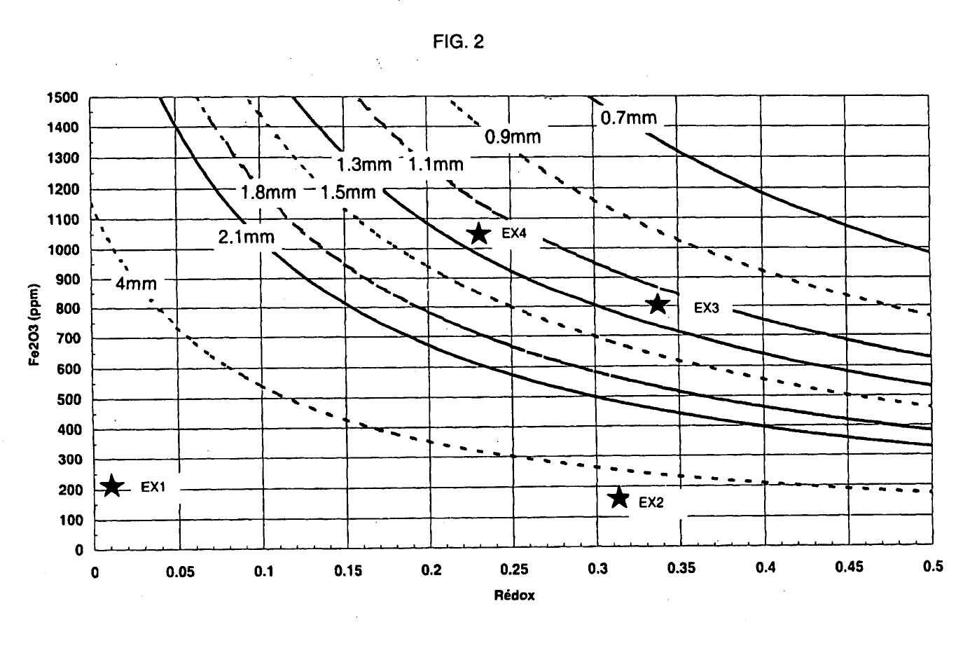

FIG. 2 illustrates curves giving, for a 91% light transmission, the total iron Fe₂O₃ content as a function of the redox for several glass thicknesses,

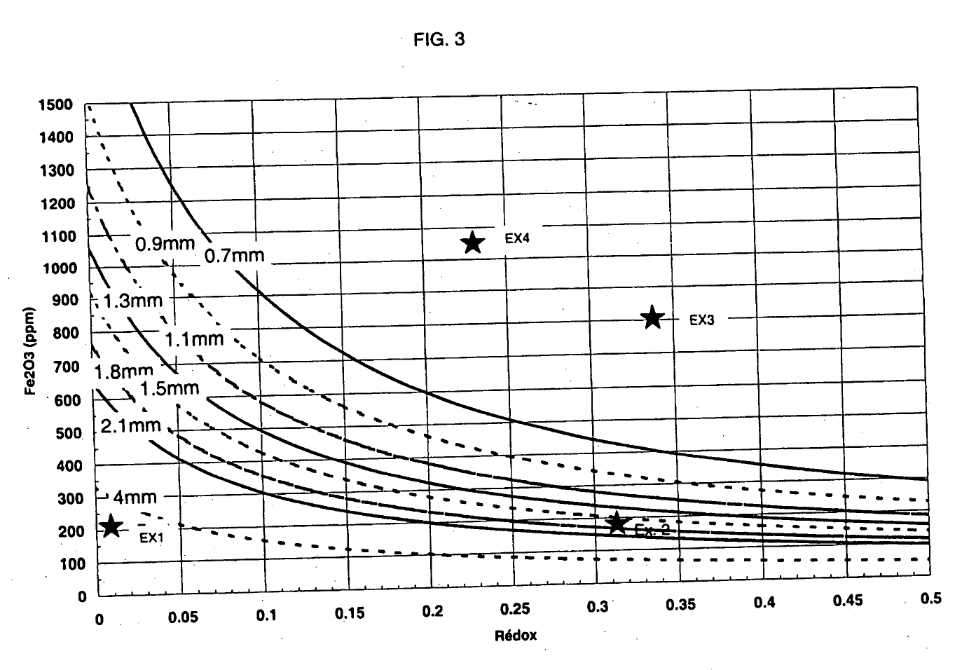

FIG. 3 illustrates curves giving, for a 91.5% light transmission, the total iron Fe₂O₃ content as a function of the redox for several glass thicknesses.

For the sake of clarity, various elements have not been drawn to scale.

FIG. 1 illustrates a backlighting system 1, intended for example to be used in an LCD screen with a size of 17″ for example. The system 1 comprises an enclosure 10, that includes an illuminant or light sources 11, and a glass diffusing substrate 20 that is joined to the enclosure 10.

The enclosure 10, with a thickness of about 10 mm, has a lower part 12 in which the light sources 11 are provided and, opposite it, an upper part 13 which is open and from which the light emitted by the sources 11 propagates. The lower part 12 has a bottom 14 against which there are reflectors 15 for reflecting, on the one hand, a portion of the light emitted by the sources 11 that is directed towards the lower part 12 and, on the other hand, a portion of the light that is not transmitted through the diffusing substrate but reflected by the glass substrate and backscattered by the diffusing layer. The arrows shown illustrate schematically the paths of the light emitted by the sources 11 and recycled in the enclosure.

The light sources 11 are, for example, discharge lamps or tubes, usually called CCFLs “Cold Cathode Fluorescent Lamps”, HCFLs “Hot Cathode Fluorescent Lamps” or DBDFLs “Dielectric Barrier Discharge Fluorescent Lamps”, or else lamps of the LED “Light Emitting Diode” type.

The diffusing substrate 20 is attached to the upper part 13 and held fast by mechanical fastening means (not illustrated) such as clips cooperating with the enclosure and the substrate, or else held in place by mutual engagement means (not illustrated) such as a groove provided on the periphery of the surface of the substrate cooperating with a peripheral rib on the enclosure.

The diffusing substrate 20 comprises a glass substrate 21 and a diffusing layer 22, with a thickness of between 1 and 20 μm, placed on one face of the glass substrate, facing or opposite the upper part 13 of the enclosure. For the composition of the layer and its deposition on the glass substrate, reference may be made to French Patent Application published under 2 809 496.

The substrate 21 for supporting the layer is made of glass that is transparent or semi-transparent in the visible wavelength range. It is characterized according to the invention by its low light absorption and has a light transmission T_{L} of least 91% over the 380 to 780 nm wavelength range. The light transmission is calculated under illuminant D₆₅ according to the EN410 standard.

Given below in the form of a table are illustrative examples of the glass substrate 21, the table indicating, for each of them, the glass composition, the contents of which are expressed in % by weight, the total iron content, the ferrous iron content, the redox and the light transmission T_{L} under illuminant D₆₅.

The light transmission T_{L} is calculated for a given thickness e of the glass substrate. Examples 1a, 1b, 2 and 3 are glass substrates that meet the at least 91% light transmission property, whereas Example 4 does not. These examples are substrates made of commercially available glass sold under the following names:
Example 1a: B270 from Schott, where e=0.9 mm;
Example 1b: B270 from Schott, where e=2.0 mm (in Examples 1a and 1b, only the thicknesses differ, the glass composition being identical);
Example 2: OPTIWHITE from Pilkington, where e=1.8 mm;
Example 3: CS77 from Saint-Gobain Glass, where e=1.1 mm; and

Example 4: PLANILUX from Saint-Gobain Glass, where e=2.1 mm.

| | Example 1a and | | | |
|---|---|---|---|---|
| | Example 1b | Example 2 | Example 3 | Example 4 |
| SiO₂ | 69.84 | 71.81 | 69 | 71.12 |
| Al₂O₃ | 0.08 | 0.6 | 0.5 | 0.5 |
| CaO | 6.8 | 8.9 | 10 | 9.45 |
| MgO | 0.15 | 4.4 | 0 | 4.4 |
| MnO | 0 | 0 | 0 | 0.002 |
| Na₂O | 8.15 | 13.55 | 4.5 | 13.8 |
| K₂O | 8.5 | 0.4 | 5.5 | 0.25 |
| BaO | 1.8 | 0 | 0 | 0 |
| TiO₂ | 0.2 | 0.02 | 0 | 0.02 |
| Sb₂O₃ | 0.45 | 0 | 0 | 0 |
| SrO | 0 | 0 | 7 | 0 |
| ZnO | 3.6 | 0.001 | 0 | 0 |
| ZrO₂ | 0 | 0.01 | 3.5 | 0 |
| Fe₂0₃ in | 200 | 160 | 800 | 1050 |
| ppm | | | | |
| FeO in | <10 | 50 | 260 | 240 |
| ppm | | | | |
| Redox | <0.05 | 0.31 | 0.33 | 0.23 |
| T_{L} in % | 91.58 (e = 0.9 mm) | 91.4 | 91.0 | 90.6 |
| | 91.51 (e = 2.0 mm) | (e = 1.8 mm) | (e = 1.1 mm) | (e = 2.1 mm) |

It should be noted that these compositions have impurities, the nature and the proportions of which are, for some of them, summarized below:
Cr₂O₃<10 ppm;
MnO<300 ppm;
V₂O₅<30 ppm;
TiO₂<1000 ppm.

The light transmission T_{L} is calculated over the 380-780 nm wavelength range according to the EN 410 standard on the basis of the transmission τ that is defined in a known manner by the Beer-Lambert Law:
τ(λ)≠(1−R(λ))²e^{-α(λ)e}
where:
R is the reflection factor;
α is the linear absorption coefficient (α and R depending on the wavelength of the light emitted); and
e is the thickness of the substrate.

The light transmission T_{L} therefore depends on the linear absorption coefficient a and the thickness e of the substrate 21.

The inventors have consequently demonstrated that the glass composition of the substrate and its thickness have an influence on the light transmission of the substrate. More particularly, the total iron content (expressed as Fe₂O₃) and the redox of the composition play a major role as regards the linear absorption coefficient. In the invention, the redox is defined as being the ratio of the content of iron in reduced form (expressed as FeO) to the total iron content (expressed as Fe₂O₃), namely the FeO/Fe₂O₃ ratio.

Thus, the thickness of the substrate may be selected according to the glass composition used.

The inventors have established a relationship between the parameters, that is to say the thickness of the glass, the total iron and the redox of the glass composition that result in the required light transmission property. This constraint relationship may be written in the following mathematical form—the total iron content in the composition is such that, for a light transmission T_{L} greater than or equal to 91%:

$${[ {Fe}_{2} {O}_{3} ]}_{t} \leq \frac{7110}{( 1.52 \times e + 0.015 ) + ( 17.24 \times e + 0.37 ) \times redox}$$

with [Fe₂O₃]ₜ expressed in ppm and corresponding to the total iron in the composition, e being the thickness of the glass in mm and the redox=[FeO]/[Fe₂O₃]ₜ, the redox being between 0 and 0.9.

As a variant, the constraint may be placed on the thickness for a given glass composition and is such that, for a light transmission T_{L} of greater than or equal to 91%:

$$e \leq \frac{7110 / {[ {Fe}_{2} {O}_{3} ]}_{t} - 0.015 - 0.37 \times redox}{1.52 + 17.24 \times redox} .$$

For a light transmission T_{L} of 91.5%, which is a preferred minimum value according to the invention, the total iron content in the composition must be even lower than that expressed above in the case of a lower transmission limit of 91%, and is such that:

$${[ {Fe}_{2} {O}_{3} ]}_{t} \leq \frac{2110}{( 1.52 \times e + 0.015 ) + ( 17.24 \times e + 0.37 ) \times redox}$$

or the thickness must be such that:

$$e \leq \frac{2110 / {[ {Fe}_{2} {O}_{3} ]}_{t} - 0.015 - 0.37 \times redox}{1.52 + 17.24 \times redox} .$$

The inequalities given above, linking the values of the Fe₂O₃/redox pair and the thickness of the substrate, may be expressed in the form of curves for characteristic glass thicknesses.

Thus, FIG. 2 illustrates curves giving, for various given thicknesses respectively, the total iron content Fe₂O₃ as a function of the redox for a light transmission T_{L} of 91%. The substrates of defined thickness, the iron and redox values of the glass composition of which lie on or below the reference curve for the same chosen thickness, are suitable for meeting the light transmission property of having to be at least 91%.

Plotted in this figure are the points EX1, EX2, EX3 and EX4 of the Fe₂O₃/redox pair of the glass composition corresponding to Examples 1a and 1b in the case of the point EX1 and to Examples 2, 3 and 4 for the other points, EX2, EX3 and EX4 respectively.

It should be noted that the point EX1 lies well below the 2.1 mm curve and even below the 4 mm curve. Consequently, the glass substrate of Examples 1a and 1b is suitable with a thickness of 0.9 mm and 2.0 mm respectively, and the glass composition could even be suitable with a higher thickness, up to 4 mm at least, in order to have a 91% minimum light transmission. However, it is not of interest when constructing the backlighting system to increase the thickness of the elements, as the current trend is towards a reduction in the size of LCD screens in terms of thickness. Therefore a thickness of more than 4 mm will not be envisaged.

The same comment applies to the point EX2, which is well below the curve corresponding to the 1.8 mm thickness of the substrate of Example 2. The glass composition of Example 2 would be suitable for a substrate with a thickness not exceeding 4.0 mm in order to have a 91% minimum light transmission.

It should also be noted that the point EX3 is below the 1.1 mm curve corresponding to the thickness of Example 3. However, with a thickness of more than 1.2 mm (curves below this point), the glass composition of Example 3 would no longer be suitable for achieving a 91% minimum transmission.

In contrast, the point EX4 is well above the 2.1 mm thickness curve corresponding to Example 4, which therefore is not suitable. However, it may be deduced therefrom that, by reducing the thickness of this type of glass so that it has a thickness of less than 1.2 mm at least (curves above this point), this glass composition would be suitable for obtaining the 91% light transmission property.

FIG. 3 illustrates curves giving, for several given thicknesses respectively, the total iron content Fe₂O₃ as a function of the redox for a minimum light transmission T_{L} of 91.50%.

This shows that, for a 91.50% light transmission, which constitutes a preferred minimum value of the invention, only Examples 1a and 1b, the point EX1 of which lies well below the curve corresponding to the 2.1 mm thickness, are suitable. The other examples are not suitable for achieving a light transmission of 91.50% at least, since the points EX2, EX3 and EX4 lie above the curves corresponding to the respective thicknesses of Examples 2, 3 and 4. It may be noted that the point EX2 is substantially above the curve corresponding to the 1.8 mm thickness and that it would be suitable in the case of the glass composition of Example 2 to produce a thinner substrate, for example with a thickness of 1.5 mm (which corresponds to the first curve lying above the point) so as to achieve the minimum 91.50% light transmission property.

The glass substrate 21 is therefore used as a support for the diffusing layer 22 so as to constitute the diffusing substrate 20 that is associated with the enclosure 10 in order to constitute the backlighting system 1. It is then possible to measure in a known manner the luminance of the illumination emanating from the enclosure and passing through the diffusing substrate. The table below summarizes, for Examples 1a, 1b and 2 to 4, the luminance associated with the light transmission. The values of the luminance given correspond to a measurement made perpendicular to the surface of the diffusing substrate and for a diffusing substrate (glass substrate and diffusing layer) having a diffuse transmission of 60%, that is to say 40% of the light is backscattered by the diffusing substrate, which backscattered light is recycled within the enclosure.

| | Example | Example | | | |
|---|---|---|---|---|---|
| | 1a | 1b | Example 2 | Example 3 | Example 4 |
| T_{L} in % | 91.58 | 91.51 | 91.4 | 91.0 | 90.6 |
| Luminance | 3997 | 3983 | 3965 | 3956 | 3811 |
| in cd/m² | | | | | |

Moreover, the glass substrate also has the advantage of serving as a support for depositing functional multi-layer coatings such as an electromagnetic insulation coating that may also constitute the diffusing layer 22 as described in French Patent Application FR 02/08289, or a coating with a low-emissivity function, an antistatic, antifogging or antisoiling function, or else a luminance-increasing function. This latter function may actually be desirable when the diffusing substrate is applied to an LCD screen.

A coating having the function of further increasing the luminance by tightening the scattering indicatrix is, for example, known in the form of an optical film sold under the name CH27 by SKC.

The table below indicates, in addition to the light transmission for the glass substrate 21, the lumination luminances obtained without the CH27 coating and with the CH27 coating on the diffusing substrate 20, and the ratio of these two luminances are expressed in %. The given values of the luminance correspond to a measurement made perpendicular to the surface of the diffusing substrate and for a diffusing substrate (glass substrate and diffusing layer) having a diffuse transmission of 60%.

| | | Without | | |
|---|---|---|---|---|
| | T_{L} in % | CH27 | With CH27 | Ratio in % |
| Example 1a | 91.58 | 3997 | 5560 | 28.10 |
| Example 1b | 91.51 | 3983 | 5489 | 27.43 |
| Example 2 | 91.4 | 3965 | 5417 | 26.80 |
| Example 3 | 91.0 | 3956 | 5303 | 25.40 |
| Example 4 | 90.6 | 3811 | 4994 | 23.68 |

Of course, it should be noted that the luminance increases with CH27—it is the function of the latter—but also that the increase in luminance is much higher when the light transmission is higher. These results show the benefit of using a substrate 21 made of the least absorbent glass possible, in order to optimize the luminance of a backlighting system. In this regard, the substrate of Example 1a or 1b will be preferred.

1. Diffusing substrate (20) comprising a glass substrate (21) and a diffusing layer (22) deposited on the said glass substrate, characterized in that the glass substrate (21) has a light transmission at least equal to 91% calculated over the 380 to 780 nm wavelength range according to the EN 410 standard.

2. Diffusing substrate according to claim 1, characterized in that the light transmission is at least equal to 91.5%.

3. Diffusing substrate according to claim 1, characterized in that the glass substrate (21) has a total iron content such that:
$${[ {Fe}_{2} {O}_{3} ]}_{t} \leq \frac{7110}{( 1.52 \times e + 0.015 ) + ( 17.24 \times e + 0.37 ) \times redox}$$
with [Fe₂O₃]ₜ expressed in ppm and corresponding to the total iron in the composition, e being the thickness of the glass in mm and the redox being defined by redox=[FeO]/[Fe₂O₃]ₜ, the redox being between 0 and 0.9.

4. Diffusing substrate according to claim 2, characterized in that the glass substrate (21) has a total iron content such that:
$${[ {Fe}_{2} {O}_{3} ]}_{t} \leq \frac{2110}{( 1.52 \times e + 0.015 ) + ( 17.24 \times e + 0.37 ) \times redox}$$
with [Fe₂O₃]ₜ expressed in ppm and corresponding to the total iron in the composition, e being the thickness of the glass in mm and the redox being defined by redox=[FeO]/[Fe₂O₃]ₜ, the redox being between 0 and 0.9.

5. Diffusing substrate according to any one of the preceding claims, characterized in that the diffusing layer (22) is composed of agglomerated particles in a binder, the said particles having a mean diameter of between 0.3 and 2 microns, the said binder being in a proportion of between 10 and 40% by volume and the particles forming aggregates whose size is between 0.5 and 5 microns.

6. Diffusing substrate according to claim 5, characterized in that the particles are semi-transparent particles and preferably mineral particles, such as oxides, nitrides and carbides.

7. Diffusing substrate according to any one of the preceding claims, characterized in that the glass substrate (21) has a glass composition based on at least the following constituents:

| | % by weight |
|---|---|
| SiO₂ | 65-75 |
| Al₂O₃ | 0-5 |
| CaO | 5-15 |
| MgO | 0-10 |
| Na₂O | 5-20 |
| K₂O | 0-10 |
| BaO | 0-5 |
| ZnO | 0-5 |

8. Diffusing substrate according to claim 1 or 2, characterized in that the glass substrate (21) has a minimum light transmission of 91.50% for a thickness e of at most 4.0 mm, with a total iron content of 200 ppm and a redox of less than 0.05.

9. Diffusing substrate according to claim 1, characterized in that the glass substrate (21) has a minimum light transmission of 91% for a thickness e of at most 4.0 mm, with a total iron content of 160 ppm and a redox of 0.31.

10. Diffusing substrate according to claim 2, characterized in that the glass substrate (21) has a minimum light transmission of 91.50% for a thickness e of at most 1.5 mm, with a total iron content of 160 ppm and a redox of 0.31.

11. Diffusing substrate according to claim 1, characterized in that the glass substrate (21) has a minimum light transmission of 91% for a thickness e of at most 1.2 mm, with a total iron content of 800 ppm and a redox of 0.33.

12. Diffusing substrate according to claim 1, characterized in that the glass substrate (21) has a minimum light transmission of 91% for a thickness e of at most 1.2 mm, with a total iron content of 1050 ppm and a redox of 0.23.

13. Use of a diffusing substrate as described in one of claims 1 to 12 for producing a backlighting system.

14. Use according to claim 13, for which the backlighting system is provided in an LCD screen.

15. Use according to claim 13, for which the backlighting system is provided in a flat lamp.
